(19) United States
(12) Patent Application Publication
(10) Pub. No.: US 2008/0070661 A1
(43) Pub. Date: Mar. 20, 2008

(54) CARD GAMES

(76) Inventor: Chi Fat Au-Yeung, Birmingham (GB)

Correspondence Address: DAVIS BUJOLD & Daniels, P.L.L.C., 112 PLEASANT STREET, CONCORD, NH, 03301, US

(21) Appl. No.: 11/854,780

(22) Filed: Sep. 13, 2007

(30) Foreign Application Priority Data
Sep. 19, 2006 (GB) 0618385.9

(51) Int. Cl. A63F 1/00; A63F 13/00; A63F 9/24; G06F 19/00

(52) U.S. Cl. 463/13; 273/292

(57) ABSTRACT

An apparatus and method for playing a card game between two or more players the game including at least one round of betting in which the players may elect one of a plurality of betting options, the round of betting proceeding until only one player remains, or all the players remaining in the game have called one another, the players simultaneously indicating their elected betting option.

This application claims priority from British Application Serial No. 0618385.9 filed Sep. 19, 2006.

### FIELD OF INVENTION

The present invention relates to card games and in particular an apparatus for playing card games between two or more players, the card game including at least one round of betting in which the players bet against one another, the round of betting being terminated when all but one of the players have dropped out of the game, or the players remaining in the game have called one another.

### BACKGROUND OF INVENTION

Definitions

Where the context so admits herein reference to the male shall include the female, use of the singular shall include the plural and vice versa and the following expressions shall bear the following meanings that is to say:

‘Hold'em’ shall mean ‘the game of Texas Hold'em Poker’;

‘Omaha’ shall mean ‘the game of Omaha Poker’;

‘Head's Up’ shall mean ‘any version of Poker played between two players using the novel playing procedures and apparatus’;

‘the Multi-player’ shall mean ‘any version of Poker played between three or more players using the novel playing procedures and apparatus’;

‘Instant-Action-Hold'em’ shall mean ‘a novel version of Hold'em regardless of the number of players using the new playing procedures and such of the novel apparatus as may be necessary for the playing of Instant-Action-Hold'em or any variation thereof’;

‘Instant-Action-Omaha’ shall mean ‘a novel version of Omaha regardless of the number of players using the new playing procedures and such of the novel apparatus as may be necessary for the playing of Instant-Action-Omaha or any variation thereof’;

‘Instant-Action-Poker’ shall mean ‘any version of Poker using the novel playing procedures and/or apparatus’;

‘the Game’ shall mean ‘any variation of Poker’;

‘Ante’ shall mean ‘the unit-value of an initial bet made prior to the cards being dealt’;

‘Call’ shall mean ‘the unit-value required to be wagered by a player so as to equal the unit-value of the total bet or raise of any other player’;

‘Raise’ shall mean ‘the unit-value additional to the unit-value of the bet which may be bet by a player during the course of a betting round’;

‘the deal’ shall mean ‘a repetitive part of the game from each posting of the ante to the showdown’;

‘community cards’ shall mean ‘the cards dealt face up and which are available for use by all players to determine their hand’;

‘the flop’ shall mean ‘the first three community cards after the first round of betting’;

‘the turn’ or ‘turn card’ shall mean ‘a fourth community card’;

‘the river’ or ‘river card’ shall mean ‘a fifth community card’;

‘the board’ shall mean ‘the five community cards comprising the flop, the turn and the river card’;

‘the showdown’ shall mean ‘the comparison of the live hands at the conclusion of each deal’;

‘betting options’ shall mean pass, check, bet, call, raise or re-raise;

‘betting round’ shall mean any stage in the deal where the players have betting options;

‘level’ or ‘betting level’ shall mean ‘that part of a betting round where the players make one playing decision either by use of action-cards or electronic input all such decisions being concurrent the betting options for such bet depending on the specific level reached in the betting round’

‘personal cards’, ‘hole cards’ or ‘pocket cards’ shall mean ‘cards dealt specifically to a player and for the sole use of that player’;

‘blind’ shall mean ‘a bet made prior to the cards being dealt; there are normally two mandatory blind bets made by the first and second players seated on the left of the dealer-button’;

‘personal hand’ shall mean ‘the cards dealt to and available for the sole use of each player consisting of that player's personal cards and any of the community cards’;

‘a wild card or cards’ shall mean ‘a specific card or cards substituted for any other card by pre-arrangement’

‘to fold’ or ‘to pass’ means ‘to abandon one's hand together with all bets made in that deal’;

‘credit’ shall mean ‘the numerical figure representing the amount in cash or chips available to a player and used for betting purposes’;

‘the pot’ shall mean ‘the aggregate amount bet by all players in any particular hand’ and ‘side pot’ shall mean ‘the aggregate bets or part thereof made in a particular hand and limited to the bets or part bets of those players who have contributed to such pot’;

‘a live player’ shall mean ‘a player who has not folded his hand’ and ‘a live hand’ shall mean ‘the hand of a live player’;

‘the first player’ shall mean ‘a player in a head's-up game who has made a bet, raise or re-raise’;

‘the second player’ shall mean ‘a player in a head's-up game who has the option of calling the first player's bet, raise or re-raise’;

‘the dealer's button’ shall mean ‘a button or other tangible object used to indicate where the first card in the deal is to be dealt and a player first entitled to take action’

‘Action-Card’ shall mean ‘any one of specially designed cards of a novel nature to be used by each player to indicate the betting options available, for example but not limited to, pass, check, bet, call, raise and re-raise or any logical combination of two or more such options presented on a single Action-Card’;

‘Action-Diamond’ shall mean ‘an actual or virtual, multi-faceted, three-dimensional figure each face of which is inscribed with different pre-determined numbers for use in any card game for status display purposes and/or as a betting tool;

‘Diamond-Face’ shall mean ‘any facet of the Action-Diamond’;

‘Diamond-Face-Number’ shall mean ‘a number inscribed on each diamond-face which number when turned face up represents the unit-value of the highest bet made to date in any deal’;

‘Dead-Diamond’ shall mean ‘a differently colored version of the Action-Diamond the purpose of which is to show the aggregate unit-value of the bets made by a player who has passed in a particular deal prior to the showdown’;

‘All-in-Diamond’ shall mean ‘a differently colored version of the Action-Diamond displaying or representing the aggregate value of the bets made by a player who has no more credit and is entitled to win only the value of the pot and/or side pot or side pots to which he has contributed’;

‘on-line’ shall mean ‘on or pertaining to the Internet and the world wide web’

In card games such as poker, after cards have been dealt to each of the players, the players make bets, depending on the strengths of their hands, as to whether their hand will beat the hands of the other players. Conventionally the betting starts with the player sitting to the left of the dealer, who may pass, check or raise. The subsequent players may then in turn, pass, check, call the raise of a previous player or re-raise the raise of a previous player. The betting continues until all but one of the players have passed, in which case the remaining player wins the pot, or all the remaining players have called one another. Such betting rounds may occur after each player has been dealt a full hand and/or following the dealing of part hands. While the invention is particularly suited to the various forms of poker, it may also be applied to other card games which include similar rounds of betting.

Poker is one of the oldest gambling card games in America emerging in the 19^{th} century from the older but still played and popular English bluffing game of brag which itself is a descendent of âs-nâs, a 14^{th} century Persian game. The word poker quite likely derives from the German version of brag, namely pochspiel, one of its calls being ich poche.

Whatever its playing or linguistic origins Poker in its many forms has been developed largely in the USA and exported throughout the world. Today it is played in casinos, designated card rooms, clubs and homes, filmed or recorded and shown on television and reported in the general and specialist press.

In recent years there have been considerable variations, and improvements, in the reputation of the game partly due to the establishment of Country or State control of gambling and gaming, partly due to the legitimization of the game through favorable news media coverage and partly due to the advent of ‘new technology’ which allows any one with access to an Internet-connected computer to play any version of the game for fun, cash or in competition in the privacy of one's own home.

To-day one of the most popular of poker games is “Texas Hold'em Poker.”

The World Series of Poker series of Competitions held annually in Las Vegas, Nevada uses No Limit Texas Hold'em to determine the World Champion.

The game of Hold'em is played with a standard deck of fifty two playing cards each deal consisting of eight distinct steps.

The object of any variation of poker is to win the pot.

A pot is won either at the showdown (as described below) by forming the best five card poker hand out of seven available cards or prior to the showdown by betting in any one of the betting rounds so to cause the other players to fold and abandon their claims to the pot

Play begins with the posting of the blinds followed by each player being dealt two cards face down. These cards are the personal, hole or pocket cards for each player. They are the only cards each player will receive individually, and they will only be required to be revealed at the showdown, making Hold'em a closed poker game.

The deal continues with a “pre-flop” betting round, beginning with the player to the left of the big blind or the player to the left of the dealer's button, if no blinds are used and continuing in a clockwise direction.

The betting options available to each player dependant upon which stage in the deal has been reached are pass, check, call, bet, raise or re-raise. If there has been no raise before the flop is dealt all live players are said to have flat-called.

After the pre-flop betting round, assuming there remain at least two players taking part in the hand, the dealer will deal the flop. The dealing of the flop is followed by a second betting round. This and all subsequent betting rounds begin with the live player closest to the left of the dealer's button (normally the small blind) and continues clockwise from player to player.

After the betting round on the flop is completed the turn card is dealt, followed by a third betting round, after which the river card is dealt. This is followed in turn by the fourth and final betting round followed by the showdown.

If at any stage there has been a bet or raise any remaining live player must call or raise in order to stay in the pot in that particular hand.

If a player bets and all other players fold, then the remaining player is awarded the pot and is not required to show his hole cards. If two or more players remain after the final betting round and the river card is checked out or the last bet has been called, the showdown takes place.

On the showdown, each live player selects and plays the best five-card hand he can make from the seven cards comprising his two hole cards and the board. A player may use both of his own two hole cards, only one, or none at all, to form his final five-card hand. If the five community cards form the player's best hand, then the player is said to be playing the board and can only hope to split the pot, since the other player can also use the same five cards to construct the same hand.

If the best hand is shared by more than one player (e.g. if no player is able to beat the board), then the pot is split equally amongst all remaining players, with any extra chips going to the person closest to the dealer button in clockwise order.

It is not unusual for players to have closely valued, but not identically ranked hands. In particular, kickers, i.e. the highest idle card or cards in a player's hand are often needed to break ties. Nevertheless, one must be careful in determining the best hand. The goal is to make the best five-card hand; if the best hands involve fewer than five cards, such as two pairs or three of a kind, then kickers are used to settle ties.

(The description of the game of Texas Hold'em has been adapted from that provided by on-line encyclopedia Wikipedia whose copyright is acknowledged.)

The basic playing method of the game of Hold'em may be summarized in the following numbered steps:

(1) two cards are dealt to each player;

(2) the first round of betting;

(3) the flop is dealt;

(4) the second round of betting;

(5) the turn card is dealt;

(6) the third round of betting;

(7) the river-card is dealt;

(8) the fourth and final round of betting;

(9) the showdown

It is accepted that there may be slight variations in the game of Hold'em as played at different venues under differing house-rules.

The Game of Omaha is a close relation of Hold'em.

Competition Omaha is played with four cards dealt to each player who must use two cards from his hole cards and three from the board to make his five-card poker hand. In all other respects the play of each deal follows that of Hold'em. In Omaha cash games up to six cards may be dealt to each player subject to the number of players involved in the deal.

The playing of any conventional version of poker, whether supervised or not, whether played in a live card-room or on-line, whether controlled by an independent dealer or not or whether part live and part electronic, is susceptible to problems or disputes relating to the value of any bet, the calculation of any side pots, the identity of the players involved in any of the side pots and the winning player destination of the pots or any of them.

Even in the absence of any delay caused by player-disputes it is unlikely that a full table playing Hold'em will see more than twenty hands dealt in an hour. Even in on-line card-rooms play is comparatively slow governed by the necessity of allowing every player equal time to consider what action to take as well as to examine the cards exposed at show-down time.

Moreover advantage may be obtained from the position of the player, relative to the dealer as a result of the sequential betting.

### OBJECT OF INVENTION

The present invention speeds up the game and also eliminates any positional advantage that may occur in the conventional forms of the game.

### SUMMARY OF INVENTION

In accordance with one aspect of the present invention an apparatus is provided for playing a card game between two or more players the game including at least one round of betting in which the players may elect one of a plurality of betting options, the round of betting proceeding until only one player remains, or all the players remaining in the game have called one another, the apparatus being characterized in that means is provided for simultaneously indicating the elected betting option of each of the players.

As a result of using simultaneous rather than sequential betting, all the players must decide their initial betting option at the same time, thereby avoiding the need to give each player in turn time to make up their mind. Furthermore no player will have the advantage of knowing what the betting option of any previous player.

The means for simultaneously indicating the elected betting option of each player, may be action cards, each card having a different betting option, e.g. pass, check, call, bet, raise and re-raise, so that each player may select the appropriate action card and all the players reveal the action cards simultaneously. Alternatively, each player may be provided with electronic input means, for example a key or touch pad, on which he may enter his elected betting option, and display means for displaying his elected betting option. The display means may interconnected or over ride means may be provided, so that the elected betting option is only displayed when all players have entered their elected betting options.

According to a further aspect of the present application, as an alternative to using chips or cash or chips representing cash in the betting stages means may be provided for indicating the value of a bet or the aggregate bets made by a player during the play of a hand.

According to one embodiment such value indicating means may be in the form of a multi-faceted, three-dimensional object or Action-Diamond each face of which is inscribed with different number, in a predetermined sequence of numbers. Alternatively the value indicating means may comprise electronic means having input means and display means and may be incorporated into the means for simultaneously indicating the elected betting option of each player, where electronic means is used for this purpose.

### DETAILED DESCRIPTION OF INVENTION

Various embodiments of games utilizing the apparatus in accordance with the present invention are now described, by way of example only.

Texas-Hold'em Poker—[Instant Action Single Raise]

The apparatus in accordance with the present invention may be used in card games to allow simultaneous betting, money or chips being used in conventional manner.

According to one embodiment of the invention Texas-Hold'em poker is played by a plurality of players. Each player has a set of action cards, each action card in the set depicting a different betting option open to the player during the play of the hand, e.g. pass, check, bet, call and raise.

At the commencement of a hand, each player in the hand places money or chips of the unit value of the anti, into the pot.

Two cards, the hole cards, are then dealt face down, to each of the players.

The players after inspecting their hole cards, then select the appropriate action card depending on whether they wish to check or bet. The selected action cards are then revealed simultaneously.

If all of the players in the hand check, the round of betting is finished and the deal goes to the next stage.

If all of the players bet, then each player pays money or chips of the unit value of the bet, into the pot. The unit value of the bet is fixed, that is; it may be a fixed amount, for example twice the unit value of the anti; or may be a fixed percentage, for example 50%, of the pot. The betting round is then finished and the deal goes to the next stage.

If one or more players bet and other players check, then said other players have an opportunity to respond, selecting the appropriate action card depending on whether they wish to pass, call or raise and revealing their selected action cards simultaneously.

If one or more of said other players pass, they take no further part in the hand. If this leaves only one player in the hand, then that player will win the hand and the pot.

If all of said other players pass or call, then said one or more players betting and said other players calling all pays money or chips of the unit value of the bet, into the pot. The betting round is then finished and the deal proceeds to the next stage.

If one or more of the other players raise, then said one or more players betting and said other players calling, have an opportunity to respond, selecting the appropriate action card depending on whether they wish to pass or call the raise and revealing their selected action cards simultaneously.

If one or more players pass, their original call of the bet is treated as provisional and they take no further part in the hand.

All the players raising and the players calling the raise, then pay money or chips of the unit value of the bet plus the unit value of the raise, into the pot. The unit value of the raise is fixed, that is; it may be a fixed amount, for example a four times the unit value of the anti; or may be a fixed percentage, for example 200%, of the pot. The betting round is then finished and the deal goes to the next stage.

Provided that two or more players remain in the hand, the deal then proceeds to:

Stage 2 in which three community cards “the flop”, are dealt face-up;

Stage 3 in which the community “turn” card is dealt face-up; and

Stage 4 in which the community “river” card is dealt face-up.

A betting round, as described above, takes place after each of these rounds, so long as more that one player remains in the hand.

If at any stage only two players remain in the game either or both players may re-raise, by an amount equal to the unit value of the raise or some other fixed value, until one or the other passes or calls.

If at any stage a player reaches his table limit, he may go All-in, remaining in the hand but taking no further part in the betting.

At completion of the final betting round, it two or more players remain, the players compare their best five card poker hand formed from their two hole cards and the five community cards, the player with the higher ranked poker hand winning the hand and the pot. If the winner is All-in, he shall win only the part of the pot to which he has contributed.

While in the above embodiment, re-raises are restricted to betting rounds in which only two players remain, according to an alternative embodiment of the game, player shall have the option of re-raising no matter how many players are in the hand.

In the above embodiments of the game, instead of using Action-Cards, each player may have electronic input and display means. Such electronic means may include a key or touch pad, by which the player may input his elected betting option, the electronic means being interconnected, so that the bets are only revealed when both players have in-putted their elected betting option. Rather than actually paying money into the pot, the electronic means may also display the value of the current aggregate bet and value of the pot, the values being updated automatically when one or more players bet, raise or re-raise.

Texas-Hold'em Poker—[Heads' Up]

According to one embodiment of the invention a Heads' Up version of Hold'em Poker is played between two players.

Each player has a set of Action-Cards, the sets of Action-Cards having cards indicating the different betting options available to each player during the play of a hand, namely pass, check, bet, call, raise or re-raise.

An Action-Diamond is provided to represent the aggregate value of the bets made by each player, at any time during play of a hand. The Action-Diamond has a number of facets with a number on each facet, the number being in series, for example an arithmetic progression 1,2,3 . . . ,n, where n is equal to the number of facets on the Action-Diamond. Alternatively, the series of numbers may be in any mathematical progression or may increase randomly. The numbers on the action diamond represent multiples of a set monetary value.

Both players will bet or be deemed to have bet an ante of a pre-determined value equal to the lowest number on the Action Diamond, prior to the cards being dealt.

At the outset of Heads' Up the Action-Diamond is in the middle of the table with the diamond-face-number set at the lowest value, representing the ante. When the Action-Diamond is in the middle of the table it is deemed to be out of play.

Each hand is commenced in the conventional manner of Texas-Hold'em Poker, stage 1 of the deal comprising the dealing of two hole cards, face down, to each of the players. The players after inspecting their hole cards, then select the appropriate Action Card depending on whether they wish to check or bet, the players revealing the Action Card they have selected, to the other player, simultaneously.

If both players have elected to check, the deal proceeds to the next stage.

If both players have elected to bet, then the number indicated by the Action-Diamond is increased to the next number in the series of numbers, the deal then proceeding to the next stage.

If one player has elected to bet and the other elected to check, the Action-Diamond is passed to the said other player and the number on the Action-Diamond is increased to the next highest number in the series of numbers, so as to display the unit-value of the bet reached in the deal. Said other player must then pass, call or raise.

If said other player passes, then he looses the hand, and the anti bet. The game will then proceed with a new hand.

If said other player calls, the Action-Diamond remains with him and the deal proceeds to the next stage.

If the said other player raises the betting status is reversed. The raise will be made by turning the Action-Diamond to the next higher number in the series and is passed to said first player. Said first player must then pass, call or re-raise. This continues until one player passes and loses the hand and the bet, the value of which is equal to the number shown by the Action-Diamond prior to the final raise, or one player calls the re-raise of the other player, when the deal will proceed to the next stage. The Action-Diamond remains with the last player to call.

Where both players have live hands the pot will be twice the aggregate bets of both players, being twice the unit-value showing on the diamond-face-number.

The deal then proceeds to:

Stage 2 in which three community cards “the flop”, are dealt face-up;

Stage 3 in which the community “turn” card is dealt face-up; and

Stage 4 in which the community “river” card is dealt face-up.

Between each of these stages further betting rounds take place. If during the previous betting rounds, both players have checked and the Action-Diamond remains in the middle of the table, the betting round commences with the players indicating their elected betting option by means of the Action Cards, as in the first betting round, as described above.

If however a bet is made in a preceding round of betting and the Action-Diamond has been passed to one of the players, then the player in whose possession the Action-Diamond is at the commencement of a further betting round has control over that betting round. Said player may check or bet.

If the player in control checks, that ends that betting round, the other player having no opportunity to bet.

If the player in control bets, the number on the Action-Diamond is increased to the next highest number in the series and the Action-Diamond is passed to the other player. The other player then has the right to pass, call or raise and the betting round proceeds as described above.

Following the dealing of the river card, a final betting round takes place, both players using their action cards to simultaneously indicate their elected betting option, the betting round proceeding in the manner of the first betting round as described above.

If during the final round of betting both players call or one player calls the raise of the other, the players then compare their best five card poker hand formed from their two hole cards and the five community cards, the player with the higher ranked poker hand winning the hand and the aggregate bet which is represented by the number shown on the Action-Diamond at the end of betting in the final betting round.

Instead of using Action-Cards and an Action-Diamond, each player may have electronic input and display means. Such electronic means may include a key or touch pad, by which the player may input his elected betting option, the electronic means being interconnected, so that the bets are only revealed when both players have in-putted their elected betting option. The electronic means may also display the value of the current aggregate bet, the value of the aggregate bet being updated automatically when one or both players bet, raise or re-raise. The electronic means may also include lockout means preventing a player who has bet, raised or re-raised, from betting after he has been called by the other player.

Texas-Hold'em Poker [Multi-Player Version]

Texas-Hold'em Poker Multi-player version is played by three or more players. As with the heads up version of the game, the hands are dealt in stages 1 to 4 as listed above, betting rounds occurring after each round.

The Action-Diamond remains in the middle of the table at all times displaying the highest bet made so far in the deal.

At the commencement of each betting round, Action-Cards are used to simultaneously indicate the elected betting option of each of the players.

If a player passes, the player ceases to have any further part in the hand, the number on the Action-Diamond, at the time the player passes, indicates the amount the player owes to the pot.

If all players elect to check then the betting round is completed, the number on the Action-Diamond is unchanged and the deal proceeds to the next stage.

If all players elect to bet the number on the Action-Diamond is increased to the next highest number in the series and the deal proceeds to the next stage.

If one or more players have elected to bet while other players have checked, the number on the Action-Diamond is increased to the next highest number in the series. The players who have checked will then use their Action-Cards to indicate whether they wish to pass, call or raise. If one or more raise the remaining players, still in the hand, have the option of passing, calling or re-raising. After each bet, raise or re-raise the number shown on the Action-Diamond is increased to the next highest number in the series. The betting round shall continue until the last bet, raise or re-raise is called by every other player still in the hand, the deal then proceeding to the next stage.

The Action-Diamond at all times will show the aggregate unit-value of the bets of each player still in the hand.

Dead-Diamonds, which are similar to the Action-Diamond, but of a different color may be placed in front of players who have passed, the Dead-Diamond showing the number shown on the Action-Diamond, when the player passed, to indicate the amount of money the player owes to the pot.

Moreover, an All-in-Diamond may be placed in front of a player to indicate that the player is still in the hand, but has reached his credit limited and will take no further part in the betting.

Alternatively, each player may have an individual Action-Diamond, the number shown on the individual Action-Diamond representing the value of the aggregate bet of the player in the hand, when the player has finished betting.

To differentiate between passing and being All-in, when the player passes he will discard his hole cards and when he is All-in he will place his Action-Diamond on his hole cards.

Again with this version of Texas-Hold'em Poker the Action-Cards and Action-Diamond may be replaced by electronic input and display means. Said electronic input and display means being adapted to simultaneously display the elected betting option of the player, display the current value of the aggregate bet of the player, display the final value of the aggregate bet of a player who has passed and display the final value of the aggregate bet of a player who is All-in.

In both versions of Texas-Hold'em Poker described above the highest number in the series of numbers on the Action-Diamond may represent a limit value for the aggregate bet for the hand, betting on the hand being terminated when the highest number is reached. Alternatively, a separate Action-Diamond may be used for each round of betting, the highest number on each Action-Diamond representing a limit to the value of the aggregate bet for each round of betting. Alternatively, there may be no limit to the value of the aggregate bet, further Action-Diamonds being used when the highest number on one Action-Diamond is reached.

Similar Heads'-up and Multi-player versions of Omaha Poker or other forms of Poker, or other similar card games, with or without community or wild cards, for example stud, five-card stud, seven-card stud, razz, lo-ball, hi-lo or brag, as played with minor variations at different venues and subject to different house-rules and all other versions or variety of a game or games using poker hands or a game or games in the extended family of poker games, may be played using the apparatus in accordance with the present invention, betting rounds occurring at appropriate stages of the deal.

Alternatively or in addition the apparatus in accordance with the present invention may be adapted for use and played as a casino house game, in which a player plays against the dealer or house.

Moreover the betting procedures may be varied, for example in the heads'-up versions of the game, both players may have the right to bet in each round, or in rounds other than the first and last rounds, rather that the player last calling a bet, raise or re-raise being in control of the betting. Alternatively the player last calling a bet, raise or re-raise may have control over the betting in the last round of betting.

In Multi-player versions, a call may be treated as a provisional call and will only take effect if all other players call. If there is a raise or re-raise, the player may withdraw his call or make a call bet upto the raise or re-raise, or may himself re-raise.

While in the games described above the bet is increased incrementally, in alternative embodiments the players may be able to bet, raise or re-raise in multiples of the increment or by random amounts. In such cases means may be provided to indicate the amount of the raise simultaneously with indication of the players elected betting option, or subsequent to the indication of the players elected betting option.

### BRIEF DESCRIPTION OF DRAWINGS

The invention is now further described, by way of example only, with reference to the accompanying drawings, in which:

FIG. 1 is a diagrammatic illustration of a casino table for a card game in accordance with the present invention; and

FIG. 2 is a diagrammatic illustration of electronic display means for use in accordance with the present invention.

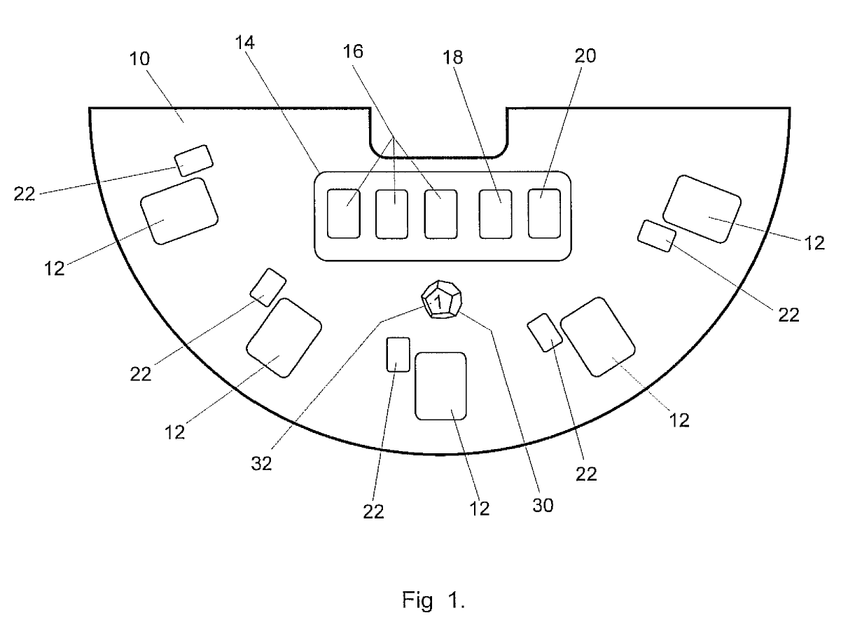

As illustrated in FIG. 1 a casino table for playing Texas-Hold'em Poker in accordance with the present invention comprises a cloth 10 marked out with a plurality of player areas 12, in which the players personal cards may be dealt. An area 14 is also marked out for the community cards, the area 14 having three boxes 16 for the flop, a box 18 for the turn card and a box 20 for the river card.

Each player has a set of action cards 22, each card of the set depicting a different betting option, e.g. pass, check, bet, call, raise and re-raise, so that the player may select the action card 22 corresponding to the betting option he wishes to make, the players then simultaneously revealing the action card 22 they have selected.

An action diamond 30 is located centrally of the table. This action diamond is a multi-faceted three-dimensional object, each face 32 of the action diamond having a different number, for example the action diamond may be a dodeccaheedron the faces of which are numbered 1 to 12. The action diamond indicates the level of the aggregate bet of each of the players still in the hand.

Further indicator means, for example multi-faceted three-dimensional objects similar to the action diamond but of different color (not shown) may be provided to indicate the individual level of the aggregate bet of a player who has passed and is no longer in the hand or to represent the level of the aggregate bet of a player who has reached his betting limit and while still in the hand is All-in.

The above apparatus may be used in the multi-player version of the game described above, when the action diamond will remain in the middle of the table, or when only two players are playing head's up version described above when in appropriate rounds of betting, the action diamond will be passed to the player calling, to indicate control of the betting.

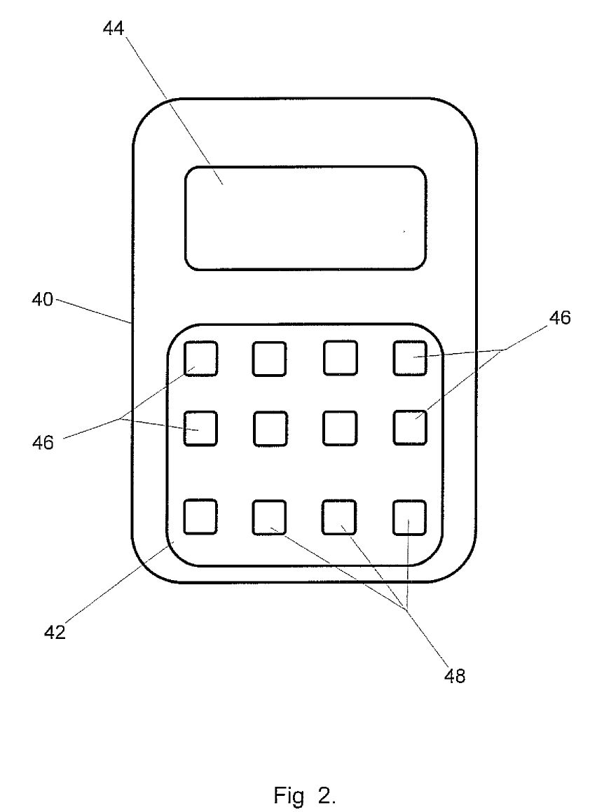

Instead of action cards 22, each player may be provided with electronic display means 40, as illustrated in FIG. 2. The electronic display 40 means by be free standing or formed as an integral part of the table. The electronic display means comprises input means 42 which may be in the form of a key pad or touch pad and a display 44. Preferably the input means is shielded so that a player may enter a betting option unobserved. The input means 42 has a series of keys or areas 46 representing different betting options, e.g. pass, check, bet, call, raise and re-raise.

Additional keys/areas 48 may also be provided by which a player may enter the value of a bet, raise or re-raise. According to one embodiment, the input means may be a touch screen which shows only the betting options appropriate to the stage of the betting round. For example for the initial bet, the touch screen may display touch areas corresponding to the betting options, check, or bet; while in subsequent stages the touch screen may display touch areas corresponding to the betting options, pass, call. raise or re-raise.

The electronic display means 40 may be interconnected or have an override means, by which display of the players elected betting option on the display 44 is inhibited until all of the players have inputted their elected betting option. The betting options will then be displayed simultaneously on the displays 44. While in the embodiment illustrated the display 44 is formed integrally of the input means 42, the display 44 may alternatively be remote from the input means 42, or a common display showing the betting options of all the players, may be used.

When two players are playing the head's up version of the game disclosed above, means may be provided for disabling the input means of the player who is not in control of the betting, until the player in control raises or the betting round reverts to no control.

The electronic display means 40 may also be used to indicate the aggregate bet of each player.

When using electronic display means, the level of each raise may be revealed simultaneously, when the bet is revealed.

Card games utilizing the apparatus in accordance with the present invention may be played or intended to be played on the Internet, or on mobile telephones, or slot machine or as a computer game or using any other gaming software or in any other electronic environment the novel apparatus or any component part thereof may be available for use in either a real, tangible or virtual form.

Card games using the apparatus in accordance with the present invention may be played in a casino, in a card-room, as a family game, as an electronic game or games, a game or games to be played on the Internet or mobile telephone, for use on slot machines or lotteries or scratch-cards.

Furthermore he apparatus in accordance with the present invention may be adapted for Internet entertainment, video slot machines, computer programs, interactive television or any other electronic medium whether currently in use or created by adaptation of the technology of a future invention.

The particular games and modes of betting disclosed above by way of example, may be modified or varied without departing from the invention.

1. An apparatus for playing a card game between two or more players the game including at least one round of betting in which the players may elect one of a plurality of betting options, the round of betting proceeding until only one player remains, or all the players remaining in the game have called one another, the apparatus including means for simultaneously indicating the elected betting option of each of the players.

2. The apparatus according to claim 1 wherein each player has a set of Action Cards, each action card representing a different bet option open to the player during a betting round.

3. The apparatus according to claim 1 wherein the Action Cards represent the bets; pass, check, bet, call, raise, re-raise.

4. The apparatus according to claim 1 wherein the means of simultaneously indicating the betting option of each player comprises electronic display means, said electronic display means having input means by which each player may input his elected betting option, the electronic display means having means to inhibit display of the player's elected betting option until all player have in-putted their elected betting options.

5. The apparatus according to claim 4 wherein each player has an electronic input/display means, the electronic/display means being interconnected to prevent display of a players elected betting option before all the players have in-putted their elected betting options.

6. The apparatus according to claim 4 wherein the input means comprises a key or touch pad.

7. The apparatus according to any one of claims 4 wherein
the input means allow a player to input the bets; pass, check, bet, call, raise, re-raise.

8. The apparatus according to claim 1 wherein means is provided for indicating the value of a bet made by a player.

9. The apparatus according to claim 8 wherein said means for indicating the value of a bet, indicates the aggregate bet made by a player during a betting round or hand.

10. The apparatus according to claim 8 wherein said means for indicating the value of a bet comprises a multi-faceted three dimensional object, said multi-faceted object having a different number of a series of numbers on each facet.

11. The apparatus according to claim 10 wherein the series of numbers constitute a mathematical progression.

12. The apparatus according to claim 11 wherein the series of numbers is 1, 2, 3, . . . , n, where n equals the number of facets on the multi-faceted object.

13. The apparatus according to claim 8 wherein said means for indicating the value of a bet comprises electronic display means.

14. The apparatus according to claim 13 wherein said electronic display means also displays the players elected betting option.

15. The apparatus according to claim 13 wherein the electronic display means incrementally adjusts the aggregate bet displayed, in accordance with the bets made by the players.

16. The apparatus according to any one of claims 13 wherein means is provided for imputing the value of a bet into the electronic display means.

17. The apparatus according to any one of claims 13 wherein means is provided for locking out the electronic display means of one player, depending on the sequence of betting, during a round of betting.

18. The apparatus according to claim 8 wherein means is provided for indicating the aggregate bet of a player when the player passes or folds.

19. The apparatus according to claim 8 wherein means is provided for indicating the aggregate bet of a player when the player reaches his table limit and remains in the game while taking no further part in the betting.

20. The apparatus according to claim 1 wherein said means for providing a simultaneous indication of the players elected betting option, means for indicating the aggregate value of the bets, means for indicating the aggregate value of the bets of a player when the player passes or folds and/or means for indicating the aggregate bet of a player when the player reaches his table limit, is provided virtually by means of the Internet, or on mobile telephones, or slot machine or as a computer game or using any other gaming software or in any other electronic environment.

21. A card game including one or more hands in which one or more cards are dealt to two or more players, each hand including at least one round of betting in which the players may elect one of a plurality of betting options, the round of betting proceeding until only one player remains, or all the players remaining in the game have called one another, the round of betting commencing with all the players indicating their elected betting option simultaneously, the bets going into a pot, the winner of the hand taking the pot.

22. The card game of claim 21 wherein each player makes an initial bet, of fixed value, prior the any cards being dealt.

23. The card game of claim 21 wherein each player is dealt a hand comprising a plurality of cards, said cards being dealt in stages, each stage of dealing being followed by a round of betting.

24. The card game of claim 21 wherein each player is dealt a hand comprising a plurality of personal and community cards, said personal and community cards being dealt in stages, each stage of dealing being followed by a round of betting.

25. The card game of claim 21 wherein, each betting round progresses through various levels at which players may elect betting options, depending in the betting options elected at the previous level.

26. The card game of claim 25 wherein, the players indicate their elected betting option simultaneously at each level of the betting round.

27. The card game of claim 25 wherein, each player may has a betting options of pass, check, bet, call raise or re-raise, depending on the level to which betting has reached in the betting round.

28. The card game of claim 25 wherein the betting options bet, raise and re-raise are of fixed values.

29. The card game of claim 28 wherein the values of the betting options bet, raise and re-raise are of fixed amounts.

30. The card game of claim 28 wherein the values of the betting options bet, raise and re-raise are fixed percentages of the pot.

31. The card game of claim 30 wherein the value of a bet is equal to 50% of the pot.

32. The card game of claim 30 wherein the value of a raise is equal to 200% of the pot.

33. The card game of claim 27 wherein if a bet or raise is called at one level of the betting round, the call may be treated as a provisional call, which may be withdrawn if there is a raise or re-raise at the next level of the betting round.

34. The card game of claim 25 wherein the betting round is finished when all the players remaining in the hand have checked or have called any bets, raises or re-raises of the previous level of betting.

35. The card game of claim 25 wherein, one or more cards are dealt to two players, if at one level of betting in a betting round, one player bets, raises or re-raises and the other player calls, in the next betting round said other player has control of the betting and if said other player calls in that next betting round, the betting round is finished.

36. The card game of claim 25 wherein a bet, raise or re-raise increases the aggregate value of the bet in mathematical progression.

37. The card game of claim 25 wherein a bet, raise or re-raise increases the aggregate value of the bet by an amount specified by the player.

38. The card game of claim 21 wherein if two or more players remain at the end of the final betting round, the outcome of the game is decided on the rank of the hands.

39. The card game of claim 38 wherein each of the players hands comprises a plurality cards selected from the cards dealt to the player.

40. The card game of claim 38 wherein each of the players hands comprises a plurality of cards selected from the personal cards dealt to the player and the community cards.

41. The card game of claim 40 wherein each of the players hands comprises five cards selected from, the personal cards dealt to the player and the community cards, the outcome of the hand being decided on poker rankings.

42. A card game for two players, said game including one or more hands in which one or more cards are dealt to each player, each hand including a plurality of rounds of betting in which the players may elect one of a plurality of betting options, including one or more of the options, bet, raise and re-raise, the round of betting proceeding until one player passes, or one player calls the other player, in which if in one betting round, one player bets, raises or re-raises and the other player calls, then in the next betting round said other player has control of the betting and if said other player checks, the betting round is finished.
